(19) United States
(12) Patent Application Publication
(10) Pub. No.: US 2018/0260269 A1
(43) Pub. Date: Sep. 13, 2018

(54) IMAGE RECOVERY METHOD AND RELATED VIDEO MANAGEMENT SERVER

(71) Applicant: VIVOTEK INC., New Taipei City (TW)

(72) Inventors: Teng-Kai Kuo, New Taipei City (TW); Che-Wei Chang, New Taipei City (TW)

(21) Appl. No.: 15/912,514

(22) Filed: Mar. 5, 2018

(30) Foreign Application Priority Data
Mar. 10, 2017 (TW) 106107884

(51) Int. Cl. G06F 11/07; G06F 11/14

(52) U.S. Cl. CPC G06F 11/0727; G06F 11/1464; G06F 11/0793

(57) ABSTRACT

An image recovery method is applied to a video management server remotely connected with a plurality of camera devices to receive a resupply image stored by each camera device while being disconnected from network. The image recovery method includes: the video management server establishing a resupply list corresponding to resupply images of the camera devices while the camera devices are recovered from a disconnection state to a connection state, then determining whether to actuate a resupply process and executing a resupply connection to receive at least one of the resupply images while the resupply process is actuated, and comparing a bandwidth usage quantity of the resupply connection with a threshold to adjust a transmission velocity of the resupply connection in accordance with a comparison result.

### BACKGROUND OF THE INVENTION

### 1. Field of the Invention

The present invention relates to an image resupply method and a video management server, and more particularly, to an image resupply method and a video management server with preferred image storing and recording function.

### 2. Description of the Prior Art

A conventional image recovery technique can restore recording information while network is recovered from a disconnection state to a connection state, which means a monitoring image captured by a remote camera device can be immediately uploaded to a video management server for immediate backup. While the image recovery technique is applied to plenty of remote camera devices and the network is just recovered to the connection state, real-time monitoring images and resupply images transmitted from the remote camera devices are uploaded to the video management server, so that a network bandwidth is occupied by the uploaded images and network transmission may be crashed due to overload. Besides, if the network is recovered to the connection state in the daytime (or in any high requirement period), the network bandwidth may be occupied by sudden uploading process of the real-time monitoring images and the resupply images, and the sudden uploading process lowers operation fluency of the network. Thus, design of a new-typed image resupply method capable of overcoming foresaid drawbacks is an important issue in the related monitoring industry.

### SUMMARY OF THE INVENTION

The present invention provides an image resupply method and a video management server with preferred image storing and recording function for solving above drawbacks.

According to the claimed invention, an image recovery method is applied to a video management server, and the video management server is remotely connected with a plurality of camera devices and used to receive a resupply image stored in a storage unit of each camera device while being disconnected from network. The image recovery method includes the video management server establishing a resupply list corresponding to resupply images of the plurality of camera devices while the plurality of camera devices is recovered from a disconnection state to a connection state, the video management server determining whether to actuate a resupply process, the video management server executing a resupply connection to receive at least one of the resupply images while the resupply process is actuated, the video management server comparing a bandwidth usage quantity of the resupply connection with a threshold, and the video management server adjusting a transmission velocity of the resupply connection in accordance with a comparison result.

According to the claimed invention, a video management server with an image recovery function is disclosed. The video management server is remotely connected with a plurality of camera devices and used to receive a resupply image stored in a storage unit of each camera device while being disconnected from network. The video management server includes a wireless receiver and a processor. The processor is electrically connected to the wireless receiver and adapted to establish a resupply list corresponding to resupply images while the plurality of camera devices is recovered from a disconnection state to a connection state, to determine whether to actuate a resupply process, to execute a resupply connection for receiving at least one of the resupply images by the wireless receiver while the resupply process is actuated, and to compare a bandwidth usage quantity of the resupply connection with a threshold, so as to adjust a transmission velocity of the resupply connection in accordance with a comparison result.

The image recovery method and the related video management server of the present invention preferably can upload the resupply image for backup on condition that parameters of the monitoring image are not varied and a frame rate of the resupply image is not decreased, therefore the image recovery method can adjust a schedule of the image recovery, such like actuating the resupply process in a specific period according to predefined setting or user's demand, for preferred transmission efficiency applied in a network off-peak period. After the resupply process is actuated, the image recovery method further can analyze at least one of the bandwidth usage quantity and the amount of the resupply connection, so as to increase or decrease the transmission velocity of the resupply connection in accordance with a foresaid analysis result, for effectively improving the transmission efficiency of the resupply connection by making best of the transmission bandwidth.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a video management server and a camera device according to an embodiment of the present invention.

FIG. 2 is a flow chart of an image recovery method according to the embodiment of the present invention.

FIG. 3 is a flow chart of velocity adjustment of the image recovery according to the embodiment of the present invention.

### DETAILED DESCRIPTION

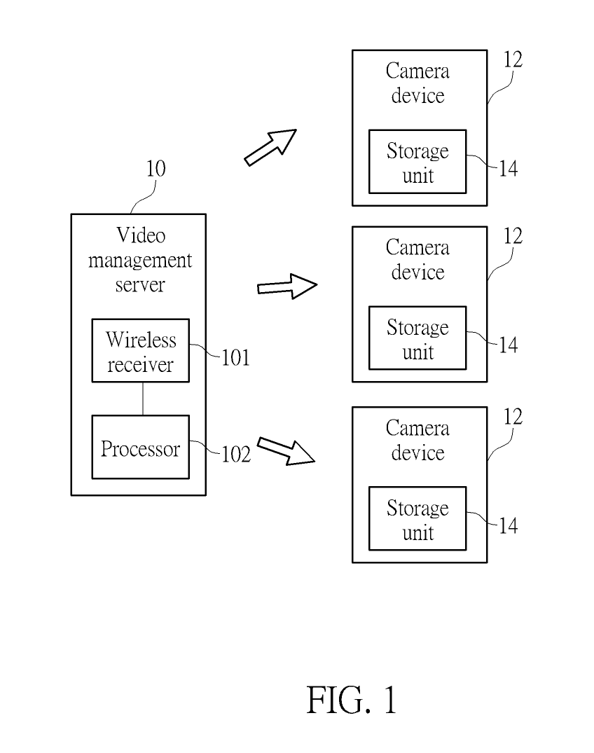

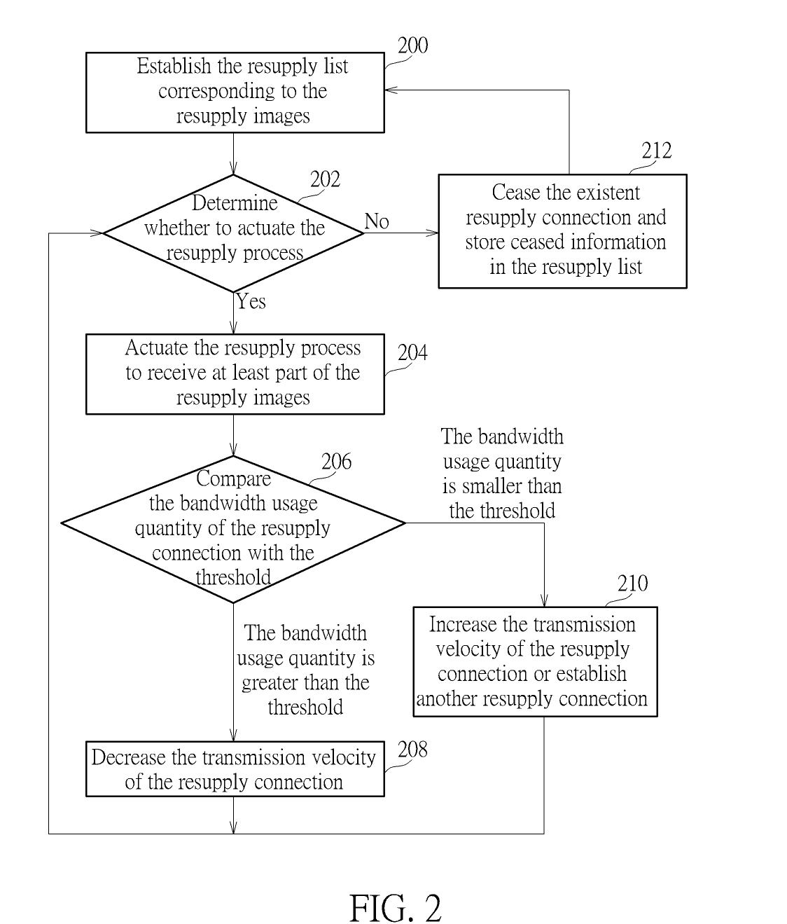

Please refer to FIG. 1 and FIG. 2. FIG. 1 is a functional block diagram of a video management server 10 and a camera device 12 according to an embodiment of the present invention. FIG. 2 is a flow chart of an image recovery method according to the embodiment of the present invention. Each camera device 12 has an individual monitoring region, and a monitoring image captured by the camera device 12 can be stored in a storage unit 14 of the camera device 12. The video management server 10 is remotely connect with a plurality of camera devices 12, and can receive the monitoring image from each camera device 12 while a related connection state is established. If the connection state is unstable, such as being disconnected but recovered to the connection state in a moment, the video management server 10 can execute the image recovery method illustrated in FIG. 2 for receiving a resupply image stored in the storage unit 14 while the corresponding camera devices 12 is disconnected from network.

The video management server 10 can be a network video recorder (NVR) or a video management system (VMS). The video management server 10 may include a wireless receiver 101 and a processor 102 electrically connected to each other. As the image recovery method is applied to the video management server 10, step 200 and step 202 are executed for a start that the processor 102 of the video management server 10 can establish a resupply list corresponding to the resupply image of the camera device 12 and determines whether to actuate a resupply process while the video management server 10 and the camera device 12 are recovered from a disconnection state to a connection state. Information about the resupply list can be corresponding to the related resupply image; for example, the information can be, but not limited to, a frame rate of the resupply image or what one of the camera devices 12 providing the resupply image.

In step 202, the video management server 10 can determine whether to actuate the resupply process by deciding whether a current time is in a resupply period, or whether a current bandwidth usage quantity is smaller than a threshold, or whether the connection state is recovered correctly. For example, the resupply process may be actuated while the current time is in the predetermined resupply period, such as in the midnight or off-duty hours; the resupply process further may be actuated while the current bandwidth usage quantity is smaller than the threshold, so that operation fluency of the network is not affected by execution of image recovery; the resupply process further may be actuated while the video management server 10 and the camera device 12 are recovered to the correct connection state. Determination of actuating the resupply process is not limited to the above-mentioned embodiments, and depends on actual demand.

Step 204 is executed while the resupply process is actuated, and the video management server 10 utilizes the wireless receiver 101 to receive the resupply image from the camera devices 12 accordingly. While the resupply list has more than one resupply images, the resupply connection can choose one of the resupply images from the resupply list for proceeding resupply, or can simultaneously choose a plural of the resupply images from the resupply list for proceeding the resupply. Then, step 206 is executed that the video management server 10 can compare the bandwidth usage quantity of the resupply connection with the usable bandwidth threshold. The said threshold can be automatically predefined by the video management server 10, or can be manually set in accordance with user's habit. While the bandwidth usage quantity of the resupply connection is greater than the threshold, step 208 is executed and the video management server 10 drives the camera device 12 to decrease a transmission velocity of the resupply connection. Adjustment of the transmission velocity can decrease transmission bit rate in a situation of keeping the original frame rate (such like frames per second). In addition, while there are plenty of resupply connection existed, step 208 further can be executed to decrease the transmission velocity of the new-added resupply connection and then the transmission velocity of the former resupply connection is kept in constant, or can be executed to optionally decrease the transmission velocity of the overall resupply connection. Adjustment of the transmission velocity depends on user's demand.

While the bandwidth usage quantity of the resupply connection is smaller than the threshold, step 210 is executed to increase the transmission velocity of the resupply connection or to establish another resupply connection. The image recovery method can optionally increase the transmission bit rate for sufficient utilization of the usable bandwidth. The image recovery method can increase the transmission velocity of the new-added resupply connection merely, or can simultaneously increase the transmission velocity of the overall resupply connection. As the extra resupply connection is established by step 210, the new-added resupply connection and the former resupply connection may have the same transmission velocity, or the new-added resupply connection and the former resupply connection may be slightly modulated to have different transmission velocity in accordance with the usable bandwidth usage quantity. After step 208 and step 210, step 202 can be executed again to determine whether to actuate the resupply process. If the video management server 10 determines the resupply process is not in need of actuation, step 212 is executed that the image recovery method can cease the existent resupply connection, and ceased information about the resupply connection can be stored in the resupply list.

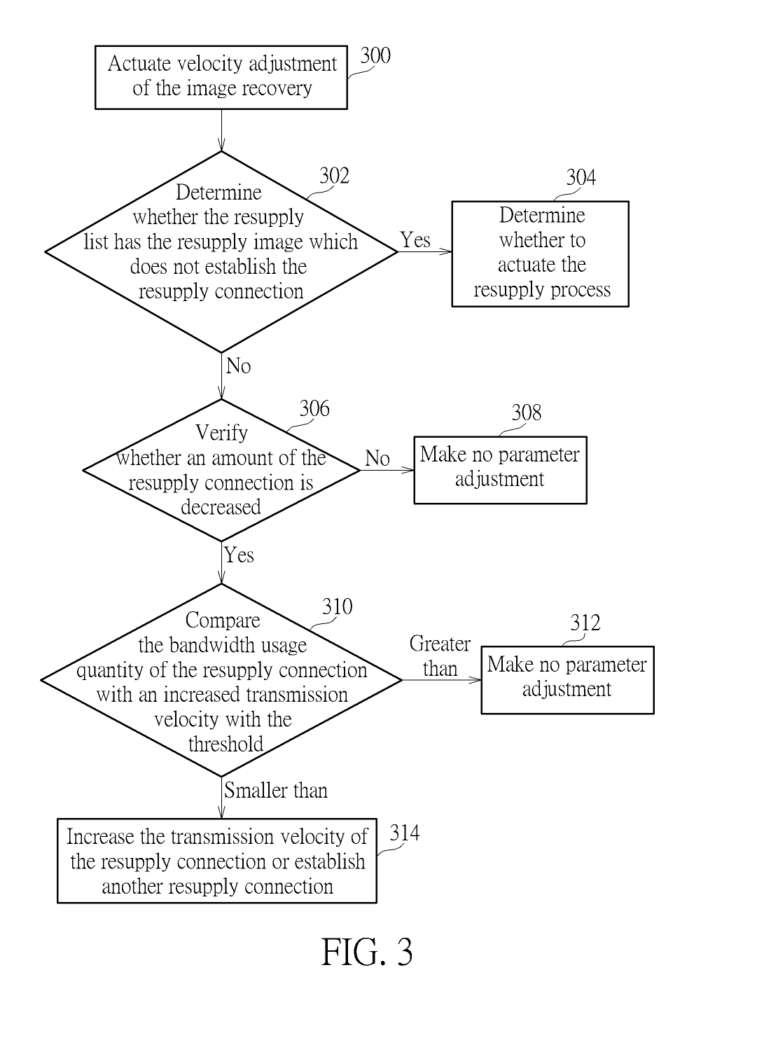

Please refer to FIG. 3. FIG. 3 is a flow chart of velocity adjustment of the image recovery according to the embodiment of the present invention. In a process of the image recovery, an amount of the resupply connection can be gradually decreased in terms of finishing the image recovery. Step 300 is executed to actuate the velocity adjustment of the image recovery. Then, step 302 is executed to determine whether the resupply list has the resupply image which does not establish the resupply connection. As the resupply list shows that there still is the resupply image which does not establish the resupply connection, step 304 is executed and the video management server 10 is driven to determine whether the resupply process is in need of actuation, such as step 202 shown in FIG. 2. As the resupply list shows that there is no resupply image which does not establish the resupply connection, step 306 is executed and the video management server 10 is used to verify whether the amount of the resupply connection is decreased. If the said amount is not decreased, the bandwidth may be fully loaded, so step 308 is executed that the image recovery method does not make parameter adjustment. If the said amount is decreased, the bandwidth can be applied for the resupply connection, so step 310 is executed that the video management server 10 computes and compares the bandwidth usage quantity of the resupply connection with an increased transmission velocity with the threshold. While the bandwidth usage quantity of the resupply connection with the increased transmission velocity is greater than the threshold (reaching or exceeding a superior limit of the usable bandwidth), step 312 is executed so the image recovery method does not make the parameter adjustment. While the bandwidth usage quantity of the resupply connection with the increased transmission velocity is not greater than the threshold, step 314 is executed to increase the transmission velocity of the resupply connection, and transmission period of the image resupply can be shortened accordingly.

In conclusion, the image recovery method and the related video management server of the present invention preferably can upload the resupply image for backup on condition that parameters of the monitoring image are not varied and the frame rate of the resupply image is not decreased, therefore the image recovery method can adjust a schedule of the image recovery, such like actuating the resupply process in a specific period according to predefined setting or user's demand, for preferred transmission efficiency applied in a network off-peak period. After the resupply process is actuated, the image recovery method further can analyze at least one of the bandwidth usage quantity and the amount of the resupply connection, so as to increase or decrease the transmission velocity of the resupply connection in accordance with a foresaid analysis result, for effectively improving the transmission efficiency of the resupply connection by making best of the transmission bandwidth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image recovery method applied to a video management server, the video management server being remotely connected with a plurality of camera devices and used to receive a resupply image stored in a storage unit of each camera device while being disconnected from network, the image recovery method comprising:
the video management server establishing a resupply list corresponding to resupply images of the plurality of camera devices while the plurality of camera devices is recovered from a disconnection state to a connection state;
the video management server determining whether to actuate a resupply process;
the video management server executing a resupply connection to receive at least one of the resupply images while the resupply process is actuated;
the video management server comparing a bandwidth usage quantity of the resupply connection with a threshold; and
the video management server adjusting a transmission velocity of the resupply connection in accordance with a comparison result.

2. The image recovery method of claim 1, wherein the video management server ceases the resupply connection and stores ceased information of the resupply connection in the resupply list while the video management server determines the resupply process is not actuated.

3. The image recovery method of claim 2, further comprising:
the video management server verifying whether an amount of the resupply connection is decreased while the video management server determines the resupply list does not have the resupply image not establishing the resupply connection;
the video management server comparing the bandwidth usage quantity of the resupply connection having an increased transmission velocity with the threshold while the amount of the resupply connection is decreased; and
the video management server determining whether to increase the transmission velocity in accordance with a comparison result.

4. The image recovery method of claim 3, wherein the video management server increases the transmission velocity while the bandwidth usage quantity is smaller than the threshold.

5. The image recovery method of claim 1, wherein the video management server decreases the transmission velocity while the bandwidth usage quantity of the resupply connection is greater than the threshold, and determines whether to establish another resupply connection while the bandwidth usage quantity of the resupply connection is smaller than the threshold.

6. A video management server with an image recovery function, the video management server being remotely connected with a plurality of camera devices and used to receive a resupply image stored in a storage unit of each camera device while being disconnected from network, the video management server comprising:
a wireless receiver; and
a processor electrically connected to the wireless receiver and adapted to establish a resupply list corresponding to resupply images while the plurality of camera devices is recovered from a disconnection state to a connection state, to determine whether to actuate a resupply process, to execute a resupply connection for receiving at least one of the resupply images by the wireless receiver while the resupply process is actuated, and to compare a bandwidth usage quantity of the resupply connection with a threshold, so as to adjust a transmission velocity of the resupply connection in accordance with a comparison result.

7. The video management server of claim 6, wherein the processor ceases the resupply connection and stores ceased information of the resupply connection in the resupply list while the video management server determines the resupply process is not actuated.

8. The video management server of claim 7, wherein the processor is applied to verify whether an amount of the resupply connection is decreased while the video management server determines the resupply list does not have the resupply image not establishing the resupply connection, and compare the bandwidth usage quantity of the resupply connection having an increased transmission velocity with the threshold while the amount of the resupply connection is decreased, so as to determine whether to increase the transmission velocity in accordance with a comparison result.

9. The video management server of claim 8, wherein the processor increases the transmission velocity while the bandwidth usage quantity is smaller than the threshold.

10. The video management server of claim 6, wherein the processor decreases the transmission velocity while the bandwidth usage quantity of the resupply connection is greater than the threshold, and determines whether to establish another resupply connection while the bandwidth usage quantity of the resupply connection is smaller than the threshold.
